(19) United States
(12) Patent Application Publication
(10) Pub. No.: US 2024/0386224 A1
(43) Pub. Date: Nov. 21, 2024

(54) VEHICLE IDENTIFICATION SYSTEM

(71) Applicant: First Step Integration, LLC, Roswell, GA (US)

(72) Inventors: Michael Thidemann, Acworth, GA (US); Elizabeth Brown Thidemann, Acworth, GA (US)

(73) Assignee: First Step Integration, LLC, Roswell, GA (US)

(21) Appl. No.: 18/319,778

(22) Filed: May 18, 2023

(51) Int. Cl. G06K 7/10

(52) U.S. Cl. CPC G06K 7/10366

(57) ABSTRACT

Disclosed is a vehicle identification system that includes a tag member. The tag member is configured to mount onto a body of a vehicle. The tag member includes a vehicle identification number (VIN), a scannable portion, a dealer identification indicator, a radio frequency identification (RFID) tag, and a vehicle manufacturing date. The VIN is configured to uniquely identify the vehicle. The scannable portion is encoded to include the VIN. The dealer identification indicator includes a portion of the VIN. The RFID tag is encoded with the portion of the VIN. The vehicle manufacturing date is associated with the vehicle. The tag member is encoded to cause a mobile device processor to: receive, from the RFID tag, the VIN; receive, from the RFID tag, the vehicle manufacturing date; and determine, based on one or more of the VIN, the vehicle manufacturing date, and a location of the vehicle.

### BACKGROUND

### Technical Field

The invention presented herein is generally directed toward a vehicle identification system, and more particularly, a vehicle identification system configured to uniquely localize a vehicle in a vehicle supply chain.

### Description of the Related Art

Currently, locating vehicles within the vehicle supply chain is a challenging task, as it involves tracking the movement of vehicles from production to delivery. For example, in a vehicle dealership where a lot may have parked within its scores of vehicles offered for sale, tracking where a vehicle is can be difficult in real-time. This can be due to a lack of communication between different stakeholders in the supply chain or the use of outdated tracking systems. Further, transportation delays can occur due to a variety of factors, including traffic, weather, or accidents. These delays can make it difficult to accurately predict when a vehicle will arrive at its destination. In some cases, the data used to track vehicles may be inaccurate, incomplete, or outdated. This can lead to confusion and errors in the supply chain. Further, vehicles can be lost or stolen during transport, which can make it difficult to locate them in the supply chain. Vehicles can also be misplaced within the supply chain, which can cause delays in production or delivery.

Therefore, there is a need for an identification system and method that can reduce transportation delays, prevent theft or loss, and improve overall efficiency in the vehicle supply chain.

Thus, in view of the above, there is a long-felt need in the industry to address the aforementioned deficiencies and inadequacies.

It is with respect to these and other considerations that the disclosure made herein is presented.

### SUMMARY

A vehicle identification system configured to uniquely localize a vehicle in a vehicle supply chain is provided, as shown in and/or described in connection with at least one of the figures.

One aspect of the present disclosure relates to a vehicle identification system that includes a tag member configured to mount onto a body of a vehicle. The tag member includes a visual identifier having one or more of a vehicle identification number (VIN), an encoded scannable portion, a dealer identification indicator, a radio frequency identification (RFID) tag, and/or a vehicle manufacturing date. The VIN is configured to uniquely identify the vehicle. The scannable portion is encoded to include the VIN or a portion of the VIN. The dealer identification indicator may further include a portion of the VIN. The RFID tag is encoded with the portion of the VIN. The vehicle manufacturing date is associated with the vehicle. The tag member is encoded to cause a mobile device processor to: receive, from the RFID tag, the VIN; receive, from the RFID tag, the vehicle manufacturing date; and determine, based on one or more of the VIN, the vehicle manufacturing date, and a location of the vehicle.

In an aspect, the vehicle identification system may further include a mobile device having a mobile device processor configured to: transmit, to a second processor, the location of the vehicle; and receive, from the second processor, a vehicle dataset comprising vehicle supply chain information.

In an aspect, the vehicle supply chain information includes at least one of: manufacturer sticker retail price information (MSRP); vehicle acquisition information; vehicle test drive historical information; and a dealership lot parking recommendation.

In an aspect, the dealership lot parking recommendation includes a recommended parking location. The dealership lot parking recommendation is based on one or more of the MSRP, the vehicle acquisition information and the vehicle test drive historical information.

In an aspect, the portion of the VIN comprises last eight characters of the VIN.

In an aspect, the RFID tag comprises an integrated circuit (IC) configured to store an identification number of the RFID tag and a data associated with one or more of the VIN and the vehicle manufacturing date.

In an aspect, the RFID tag comprises an antenna configured to transmit the data stored in the IC to the mobile device.

In an aspect, the VIN is printed on the visual identifier based on a VIN data scanned through a handheld scanner and a mobile application.

In an aspect, the tag member is further encoded to cause the handheld scanner to scan and capture the VIN data displayed on a VIN plate of the vehicle.

In an aspect, the handheld scanner is an RFID scanner.

In an aspect, the mobile application is installed in the mobile device.

Another aspect of the present disclosure relates to a method that initiates with a step of obtaining data pertaining to a vehicle identification number (VIN) through a handheld scanner. The method further includes a step of obtaining data pertaining to a type and color of a vehicle through an imager. The method then includes a step of obtaining data pertaining to a location and time through a camera. The method includes a step of mapping, by a computing device, the data obtained by the handheld scanner, the imager, and the camera to indicate a location of the vehicle.

In an aspect, the method includes a step of presenting the location of the vehicle over a display associated with a mobile device connected with the computing device over a network.

In an aspect, the computing device is a cloud system.

In an aspect, the cloud system downloads a map from the data obtained by the handheld scanner, the imager, and the camera to indicate the location of the vehicle.

In an aspect, the cloud system utilizes a plurality of machine learning algorithms to identify the location of the vehicle.

In an aspect, the handheld scanner is an RFID scanner.

In an aspect, the imager is an RGB color camera.

Another aspect of the present disclosure relates to a radio frequency identification (RFID) tag scannable by a mobile device and encoded to cause the mobile device to: receive a vehicle identification number (VIN); receive a vehicle manufacturing date, wherein the VIN and vehicle manufacturing date are stored in an integrated circuit (IC) of the RFID tag; and determine, based on one or more of the VIN and the vehicle manufacturing date, a location of a vehicle.

In an aspect, the RFID tag is removably attached to the vehicle.

In an aspect, the RFID tag includes an antenna configured to transmit a data related to the VIN and the vehicle manufacturing date stored in the IC to the mobile device.

In an aspect, the VIN and the vehicle manufacturing date transmitted to the mobile device are stored in a cloud system for analysis of the location of the vehicle.

In an aspect, the mobile device comprises a mobile application to scan a VIN data displayed on a VIN plate of the vehicle.

Another aspect of the present disclosure relates to a mobile device that includes a mobile device processor. The mobile device processor is configured to receive a vehicle identification number (VIN) from a radio frequency identification (RFID) tag. The mobile device processor is configured to receive a vehicle manufacturing date from the RFID tag, wherein the VIN and vehicle manufacturing date are stored in an integrated circuit (IC) of the RFID tag. The mobile device processor is configured to determine, based on one or more of the VIN and the vehicle manufacturing date, a location of a vehicle.

In an aspect, the mobile device processor is further configured to transmit, to a second processor, the location of the vehicle. The mobile device processor is further configured to receive, from the second processor, a vehicle dataset comprising vehicle supply chain information.

In an aspect, the VIN and the vehicle manufacturing date are stored in a cloud system for analysis of the location of the vehicle.

In an aspect, the mobile device processor is configured to execute a plurality of instructions pertaining to scanning VIN data displayed on a VIN plate of the vehicle.

Accordingly, one advantage of the present invention is that it efficiently reduces transportation delays, prevents theft or loss, and improves overall efficiency in the vehicle supply chain.

Other embodiments and advantages will become readily apparent to those skilled in the art upon viewing the drawings and reading the detailed description hereafter, all without departing from the scope of the disclosure. The drawings and detailed descriptions presented are to be regarded as illustrative in nature and not in any way as restrictive.

Other features of the example embodiments will be apparent from the drawings and from the detailed description that follows.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates a network implementation diagram of the vehicle identification system, in accordance with one embodiment of the present invention.

FIG. 2 illustrates a block diagram of the vehicle identification system, in accordance with one embodiment of the present invention.

FIG. 3 illustrates a perspective view of a mobile device scanning the tag member mounted onto a body of a vehicle, in accordance with at least one embodiment.

FIG. 4 illustrates a flow diagram of a method to provide visibility of a vehicle supply chain, in accordance with at least one embodiment.

FIG. 5 illustrates a perspective view of a mobile device scanning the tag members attached to the parked vehicles present in an aisle in a dealership parking lot, in accordance with at least one embodiment.

FIG. 6 illustrates a perspective view of a parked vehicle map with a close view of vehicle information abstracted for a particular vehicle, in accordance with at least one embodiment.

### DETAILED DESCRIPTION

The disclosure will be described more fully hereinafter with reference to the accompanying drawings, in which example embodiments of the disclosure are shown, and not intended to be limiting.

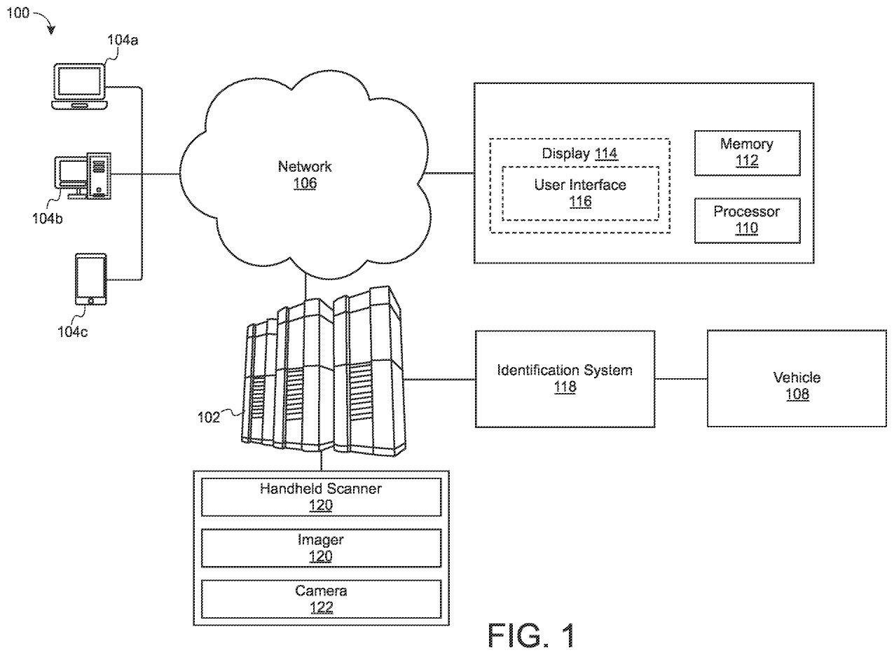

FIG. 1 illustrates a network implementation diagram 100 of the vehicle identification system 118, in accordance with one embodiment of the present invention. The vehicle identification system 118 is removably attached to a vehicle 108 using, for example, an adhesive backing or other attachment means. The vehicle identification system 118 presents vehicle and dealer-related data that are captured through various electronic devices. These electronic devices capture the vehicle and dealer-related data and transmit it to a computing device 102. For example, a user may scan a portion of a dealership lot using a camera device of a smartphone or dedicated mobile device. In another example, the user, at a vehicle dealership lot, uses a mobile application installed in his/her mobile device or smartphone to retrieve information about vehicles. The mobile application is designed to push localization information, which is the location of the vehicles, to the computing device. The computing device then processes the data and returns a visual output of the critical vehicle information on the user's mobile device. In simpler terms, a person visits a car dealership and uses the mobile application to find information about the cars on the lot. The mobile application sends location information to the computing device, and then displays important information about the cars on the mobile device's screen.

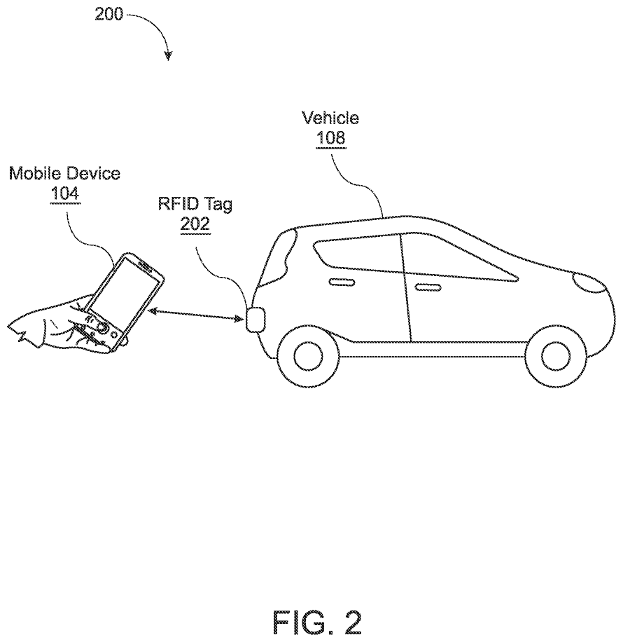

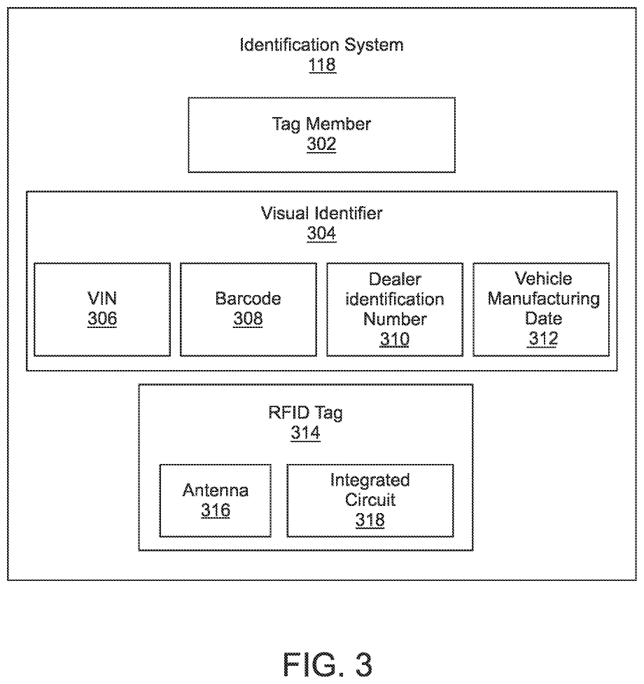

Examples of the electronic devices include but are not limited to a handheld scanner 120, an imager 122, a camera 124, and one or more mobile devices 104 (for example, a laptop 104a, a desktop 104b, and a smartphone 104c). Other examples of the mobile devices 104, may include but are not limited to a phablet, and a tablet. In an embodiment, the mobile devices 104 include a mobile device processor 110, a memory 112, a display 114, and a user interface 116. The specific functions of the mobile device processor 110, the memory 112, the display 114, and the user interface 116 are explained in conjunction with FIG. 2 and FIG. 3.

In an embodiment, the computing device 102 and the mobile device 104 are connected over a network 106. Network 106 may be a wired or a wireless network, and the examples may include but are not limited to the Internet, Wireless Local Area Network (WLAN), Wi-Fi, Long Term Evolution (LTE), Worldwide Interoperability for Microwave Access (WiMAX), and General Packet Radio Service (GPRS). In an embodiment, the computing device 102 is a cloud system that includes a second processor 126 that receives data captured by the one or more electronic devices.

Typically, a vehicle is identified by a vehicle identification number (VIN) printed on a VIN plate of the vehicle. In operation, the VIN is scanned by the handheld scanner 120. In an embodiment, the handheld scanner 120 is an RFID scanner. The data relating to the type and color of vehicle 108 is obtained by the imager 122. In an embodiment, the imager 122 is an RGB camera. The camera 128 is configured to capture a video of the vehicle to obtain data related to the GPS location and time. Then the data obtained by the handheld scanner 120, the imager 122, and the camera 128 are transmitted to the computing device 102. The computing device 102 maps the received data to indicate the location of vehicle 108. For example, the user may cause the handheld scanner to determine the location of a vehicle by scanning its VIN plate. In an implementation, the user aims the handheld scanner at the VIN plate of the vehicle and initiates a scan. The handheld scanner's processor processes the scanned data and recognizes the VIN. The handheld scanner then connects to a remote server, which contains a database of vehicle information associated with the VINs. The remote server retrieves the location, type, and color of the vehicle associated with the scanned VIN. The remote server transmits this information to the computing device. The computing device receives the information and uses it to determine the location of the vehicle, either by displaying the location on a map or providing navigation directions to the user. Therefore, by scanning the VIN plate of a vehicle with a handheld scanner, a user can retrieve information about the vehicle's location, type, and color from a remote server. This can be useful for locating a parked vehicle in a crowded area, or for tracking a vehicle's movements in real time.

In an embodiment, the computing device 102 is a cloud system that downloads a map from the data obtained by the handheld scanner 120, the imager 122, and the camera 124 to indicate and locate the location of vehicle 108. The cloud system may utilize a plurality of machine learning algorithms to identify the location of the vehicle 108. For example, the system may utilize Convolutional Neural Networks (CNNs) for vehicle image recognition and can be applied to vehicle detection in aerial or satellite imagery. In another embodiment, the Support Vector Machines (SVM) for vehicle detection in images or video streams. In another embodiment, random forests algorithms can be used for classification and regression tasks. Random forests algorithms can be applied to vehicle detection by analyzing features such as color, shape, and texture. In an embodiment, the machine learning algorithms are trained and stored in the cloud system. The machine learning algorithms may include but are not limited to decision tree-based machine learning methods, artificial neural networks, convolutional neural networks (CNNs), logistic regression, naive Bayes, nearest neighbor, support vector machines (SVMs), boosted tree learning methods, and/or generative neural networks.

The mobile device 104 includes a display 114. The location of the vehicle 108 is presented over the display 114 of the mobile device 104. In an embodiment, the display 114 has a User Interface (UI) 116 that may be used by the user or an administrator to initiate a request to view the VIN data and provide various inputs to the mobile application. For example, a user may wish to track the location of the vehicle or may want to navigate to the real-time location of the vehicle. The processor may cause the user interface 116 of the mobile device 104 to display the navigation path to the location of the vehicle. This can be useful for locating a parked vehicle in a crowded area, or for tracking a vehicle's movements in real time.

In an embodiment, the User Interface (UI or GUI) 116 is a convenient interface for accessing the information related to the VIN data of the vehicle. In one example embodiment, the mobile device processor 110 may receive an instruction to retrieve historical information of the vehicle. The mobile device processor 110 may retrieve information about the vehicle's past ownership, accidents, repairs, and other important events and display the historical information of the vehicle to the GUI 116.

Further, the mobile device 104 includes a memory 112 and a mobile device processor 110 to store and execute the mobile application that performs analysis on the scanned data received from the VIN plate. The memory 112 may be a non-volatile memory or a volatile memory. Examples of nonvolatile memory may include, but are not limited to flash memory, a Read Only Memory (ROM), a Programmable ROM (PROM), Erasable PROM (EPROM), and Electrically EPROM (EEPROM) memory. Examples of volatile memory may include but are not limited to Dynamic Random-Access Memory (DRAM), and Static Random-Access Memory (SRAM).

For example, the user opens a mobile application on his/her mobile device to retrieve information related to the VIN of a specific vehicle. This information could include the vehicle's make, model, year, and other details that are associated with the VIN. The mobile device's memory 112 stores and executes the mobile application to access the information related to the VIN.

FIG. 2 illustrates a block diagram of the vehicle identification system, in accordance with one embodiment of the present invention. FIG. 2 is explained in conjunction with FIG. 1. The vehicle identification system 118 includes a tag member 202. The tag member 202 is configured to mount onto a body of vehicle 108 (shown in FIG. 1 and FIG. 3). The tag member 202 includes a visual identifier 204. The visual identifier 204 includes a vehicle identification number (VIN) 208, a scannable portion 210, a dealer identification indicator 212, a vehicle manufacturing date 214, and a radio frequency identification (RFID) tag 214.

The VIN 206 is configured to uniquely identify the vehicle 108. According to an embodiment herein, the VIN 206 is a unique code assigned to every vehicle. The VIN 206 may consist of about 17 characters, for example, 1GNEK13Z23J153495. The scannable portion 210 is encoded to include the VIN 206. Examples of encoding methods include but are not limited to 3D, QR, and barcode, among other possible encoding methods. There are several types of barcodes, including UPCs, EAN codes, and Code 39 barcodes. These encoding methods are used to store information in a format that can be easily read and processed by scanning machines.

In one embodiment, the VIN 206 may be used to identify the vehicle for registration purposes. VIN allows the authorities to keep track of vehicle ownership and ensure that the vehicle is properly registered and licensed. In another embodiment, the VIN is used to generate vehicle history reports, which provide information about the vehicle's past ownership, accidents, repairs, and other important events.

The dealer identification indicator 212 includes a portion of the VIN 206. In an embodiment, the portion of the VIN comprises the last eight characters of the VIN. According to an embodiment herein, the dealer identification indicator 212 is a unique code assigned to every authorized dealer of a specific vehicle manufacturer. The dealer identification indicator 212 can be used to identify which dealer sold a particular vehicle or to track the sales and distribution of vehicles across different dealerships. For example, in some aspects, the users may want to purchase a used vehicle, and they come across a vehicle that they like. The users want to know which dealership originally sold the car, so they can gather more information about its history and maintenance records. To do this, the users may require dealer identification indicator 212 from the VIN plate.

The RFID tag 214 is encoded with the portion of the VIN 206. The vehicle manufacturing date 212 is associated with the vehicle 108. The vehicle manufacturing date 212 of the vehicle can typically be found within the VIN, specifically in characters 10-11. The two characters represent the model year of the vehicle, while characters 12-17 represent the production sequence number.

The tag member 202 is encoded to cause a mobile device processor 110 (shown in FIG. 1) to receive the VIN 206 from the RFID tag 214. The mobile device processor 110 then receives the vehicle manufacturing date 212 from the RFID tag 214. The mobile device processor 110 then determines the location of the vehicle based on either the VIN or the vehicle manufacturing date. The mobile device processor 110 is further configured to transmit the location of the vehicle to the second processor 126 of the computing device 102.

The mobile device processor 110 and the second processor 126 may include at least one data processor for executing program components for executing user-or system-generated requests. The mobile device processor 110 and the second processor 126 may include specialized processing units such as integrated system (bus) controllers, memory management control units, floating-point units, graphics processing units, digital signal processing units, etc. The mobile device processor 110 and the second processor 126 may include a microprocessor, such as AMD® ATHLON® microprocessor, DURON® microprocessor OR OPTERON® microprocessor, ARM's application, embedded or secure processors, IBM® POWERPC®, INTEL′S CORE® processor, ITANIUM® processor, XEON® processor, CELERON® processor or other line of processors, etc. The mobile device processor 110 and the second processor 126 may be implemented using a mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Lastly, the mobile device processor 110 is configured to receive a vehicle dataset comprising vehicle supply chain information from the second processor 126. In an embodiment, the vehicle supply chain information includes at least one of: manufacturer sticker retail price information (MSRP); vehicle acquisition information; vehicle test drive historical information; and a dealership lot parking recommendation. In an embodiment, the dealership lot parking recommendation includes a recommended parking location. The dealership lot parking recommendation is based on one or more of the MSRP, the vehicle acquisition information, and the vehicle test drive historical information.

In an embodiment, the vehicle acquisition information is associated with the dealership's acquisition of the vehicles being offered for sale. The vehicle acquisition information includes dealer costs, transfer fees, taxes paid by the dealer, and/or other associated vehicle acquisition costs. For example, in one aspect, the dealer may purchase a pre-owned vehicle from a first buyer or a vehicle auction. The vehicle acquisition information may include the purchase price paid for the vehicle, taxes paid or owed for the vehicle purchase, title fees, tag fees, transfer fees, fuel usage information and costs, and/or other costs associated with acquiring the vehicle.

In an embodiment, the RFID tag 214 comprises an integrated circuit (IC) 216 configured to store an identification number of the RFID tag and data associated with one or more of the VIN 206 and the vehicle manufacturing date 212. The RFID tag 214 further includes an antenna 218 configured to transmit the data stored in the IC 216 to the mobile device 104. In an embodiment, the VIN 206 and the vehicle manufacturing date 212 transmitted to the mobile device 104 are stored in the cloud system 102 for analysis of the location of the vehicle 108.

FIG. 3 illustrates a perspective view 300 of the mobile device 104 scanning the tag member 202 mounted onto the body of vehicle 108, in accordance with at least one embodiment. FIG. 3 is explained in conjunction with FIG. 1 and FIG. 2. The tag member 202 is encoded to cause the handheld scanner 120 and a mobile application to scan and capture the VIN data displayed on a VIN plate of the vehicle 108. In an embodiment, the VIN is printed on the visual identifier 204 based on a VIN data scanned through the handheld scanner 120 and a mobile application. In an embodiment, the handheld scanner 120 is an RFID scanner. In an embodiment, the mobile application is installed in the mobile device 104. In an embodiment, the mobile application is executable on the mobile devices 104 of the user and implemented on one or more operating systems such as Android®, iOS®, Windows®, etc. In an embodiment, the mobile application is commercialized as an application for scanning the VIN plate of the vehicles which is a software application, or a mobile application, or a web application.

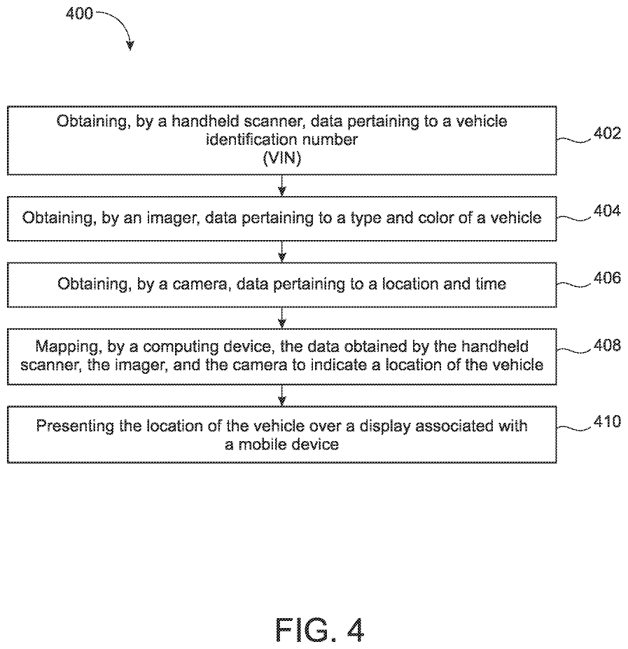

FIG. 4 illustrates a flow diagram 400 of a method to provide visibility of a vehicle supply chain, in accordance with at least one embodiment. The method initiates with a step 402 of obtaining data pertaining to a vehicle identification number (VIN) through a handheld scanner. In an embodiment, the handheld scanner is an RFID scanner. The method further includes a step 404 of obtaining data pertaining to a type and color of a vehicle through an imager. In an embodiment, the imager is an RGB color camera. The method then includes a step 406 of obtaining data pertaining to a location and time through a camera. The method includes a step 408 of mapping, by a computing device, the data obtained by the handheld scanner, the imager, and the camera to indicate a location of the vehicle. In an embodiment, the computing device is a cloud system. The cloud system downloads a map from the data obtained by the handheld scanner, the imager, and the camera to indicate the location of the vehicle. Further, the cloud system utilizes a plurality of machine-learning algorithms to identify the location of the vehicle. Further, the method includes a step 410 of presenting the location of the vehicle over a display associated with a mobile device connected with the computing device over a network.

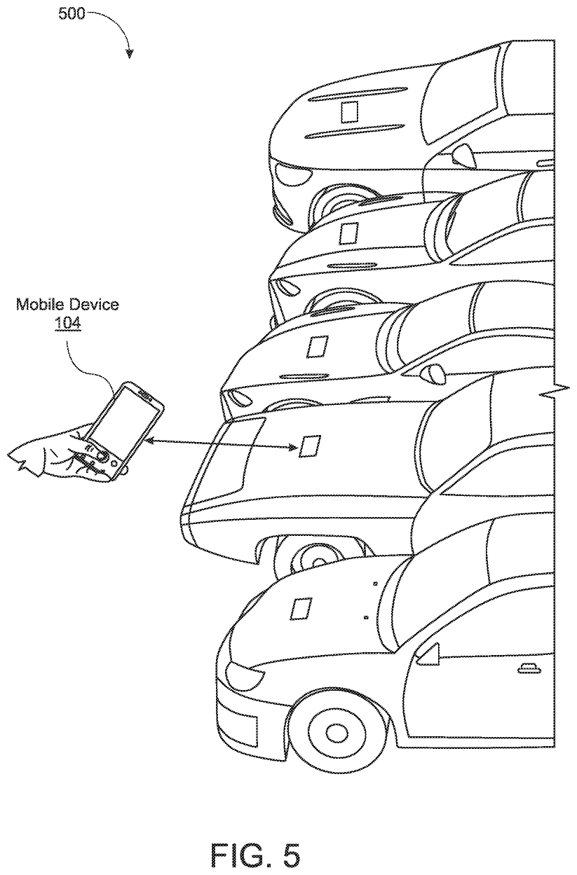

FIG. 5 illustrates a perspective view 500 of a mobile device 104 scanning the tag members (combinedly referred to as 202) attached to the parked vehicles present in aisle 502 in a dealership parking lot, in accordance with at least one embodiment. In an embodiment, the tag members 202 are stickers placed on a newly manufactured vehicle at the point of final assembly. The stickers display the full VIN, VIN in barcode format, and the last eight characters of the VIN, and are RFID encoded with the full VIN. In the implementation, the handheld scanner or the mobile application installed in the mobile device 104 is used to scan the VIN plate on the vehicle and use this scanned information to print the tag for the application. Then, the vehicle identification system i.e., a removably fixed vehicle tag having an RFID chip and image or description of the vehicle identification number disposed on the face of the vehicle identification system. The tag members include the manufacturing dates of the vehicles and a second unique identifier like UC74 i.e., a dealer identification (ID) indicator. In an embodiment, the sticker has the potential to be used by various systems and uses, and barcode scanning with RFID scanning can be combined with human-readable data. Thus, the sticker uses the full VIN and provides the barcode, RFID, and human-readable applications in one.

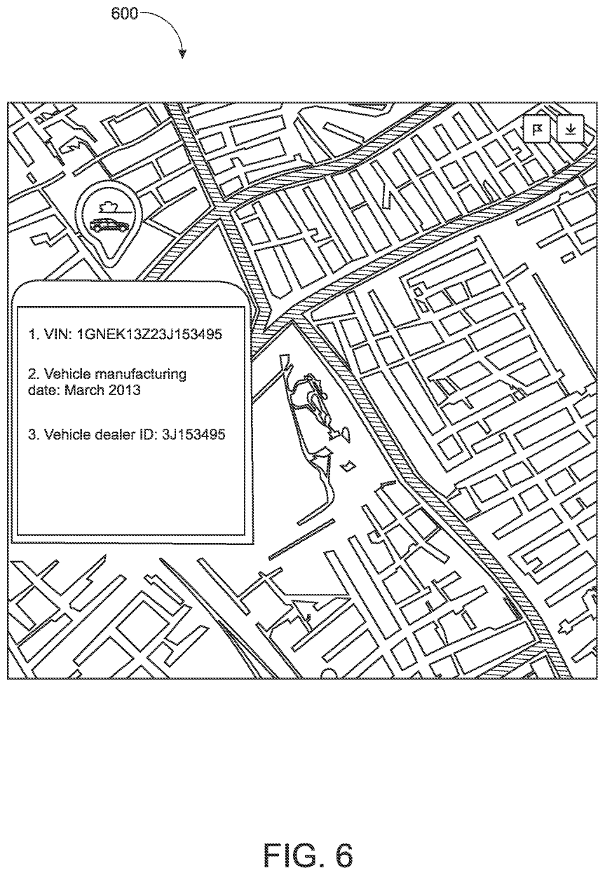

FIG. 6 illustrates a perspective view 600 of a parked vehicle map with a close view 602 of vehicle information abstracted for a particular vehicle 604, in accordance with at least one embodiment. The cloud system obtains the vehicle color and vehicle type information from the imager, VIN from the RFID scanner, GPS information, and time information from the camera. Once the location is obtained by the cloud system, the VIN, vehicle manufacturing date, and vehicle dealer identification are displayed on one or more of the mobile devices. Then the cloud system maps the information and indicates the position of the vehicle.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

1. A vehicle identification system, comprising:
a tag member configured to mount onto a body of a vehicle, the tag member comprising:
a vehicle identification number (VIN) configured to uniquely identify the vehicle;
a scannable portion encoded to include the VIN;
a dealer identification indicator comprising a portion of the VIN, wherein the dealer identification indicator is configured to identify a dealer associated with the vehicle;
a radio frequency identification (RFID) tag encoded with the VIN; and
a vehicle manufacturing date associated with the vehicle, wherein the tag member is encoded to cause a mobile device processor to:
receive, from the RFID tag, the VIN;
receive, from the RFID tag, the vehicle manufacturing date;
determine, based on one or more of the VIN and the vehicle manufacturing date, a location of the vehicle, and
display, the VIN, the vehicle manufacturing date, the location of the vehicle, and the dealer identification indicator on a mobile device.

2. The vehicle identification system according to claim 1, wherein the mobile device processor is further configured to:
transmit, to a second processor, the location of the vehicle; and
receive, from the second processor, a vehicle dataset comprising vehicle supply chain information.

3. The vehicle identification system according to claim 2, wherein the vehicle supply chain information comprises at least one of:
manufacturer sticker retail price information (MSRP);
vehicle acquisition information;
vehicle test drive historical information; and
a dealership lot parking recommendation comprising a recommended parking location, wherein the dealership lot parking information is based on one or more of the MSRP, the vehicle acquisition information, and the vehicle test drive historical information.

4. The vehicle identification system according to claim 1, wherein the portion of the VIN comprises last eight characters of the VIN.

5. The vehicle identification system according to claim 1, wherein the RFID tag comprises an integrated circuit (IC) configured to store an identification number of the RFID tag and a data associated with one or more of the VIN and the vehicle manufacturing date.

6. The vehicle identification system according to claim 5, wherein the RFID tag comprises an antenna configured to transmit the VIN and the vehicle manufacturing date stored in the IC to a memory operative with the mobile device processor.

7. The vehicle identification system according to claim 1, wherein the VIN is printed on a visual identifier based on a VIN data scanned through a handheld scanner and a mobile application.

8. The vehicle identification system according to claim 7, wherein the tag member is further encoded to cause the handheld scanner to scan and capture the VIN data displayed on a VIN plate of the vehicle.

9. The vehicle identification system according to claim 7, wherein the handheld scanner is an RFID scanner.

10. The vehicle identification system according to claim 7, wherein the mobile application is installed in a mobile device, wherein the mobile device comprises the mobile device processor, and the memory.

11. A method comprising:
obtaining, by a handheld scanner, data pertaining to a vehicle identification number (VIN);
obtaining, by an imager, data indicative of one or more of a vehicle type and a vehicle color;
obtaining, by a camera, data pertaining to a location and time; and
mapping, by a computing device, the data obtained by the handheld scanner, the imager, and the camera to indicate a location of the vehicle.

12. The method according to claim 11, comprises a step of presenting the location of the vehicle over a display associated with a mobile device connected with the computing device over a network.

13. The method according to claim 11, wherein the computing device is a cloud system.

14. The method according to claim 13, wherein the cloud system downloads a map from the data obtained by the handheld scanner, the imager, and the camera to indicate the location of the vehicle.

15. The method according to claim 13, wherein the cloud system utilizes a plurality of machine learning algorithms to identify the location of the vehicle.

16. The method according to claim 11, wherein the handheld scanner is an RFID scanner.

17. The method according to claim 11, wherein the imager is an RGB color camera.

18. A radio frequency identification (RFID) tag scannable by a mobile device and encoded to cause the mobile device to:
receive a vehicle identification number (VIN);
receive a vehicle manufacturing date, wherein the VIN and vehicle manufacturing date are stored in an integrated circuit (IC) of the RFID tag; and
determine, based on one or more of the VIN and the vehicle manufacturing date, a location of a vehicle.

19. The RFID tag according to claim 18 is removably attached to the vehicle.

20. The RFID tag according to claim 18, comprises an antenna configured to transmit a data related to the VIN and the vehicle manufacturing date stored in the IC to the mobile device.

21. The RFID tag according to claim 18, wherein the VIN and the vehicle manufacturing date transmitted to the mobile device is stored in a cloud system for analysis of the location of the vehicle.

22. The RFID tag according to claim 18, wherein the mobile device comprises a mobile application to scan a VIN data displayed on a VIN plate of the vehicle.

23. A mobile device, comprising:
a mobile device processor configured to:
receive a vehicle identification number (VIN) from a radio frequency identification (RFID) tag;
receive a vehicle manufacturing date from the RFID tag, wherein the VIN and vehicle manufacturing date are stored in an integrated circuit (IC) of the RFID tag; and
determine, based on one or more of the VIN and the vehicle manufacturing date, a location of a vehicle.

24. The mobile device according to claim 23, wherein the mobile device processor is further configured to:
transmit, to a second processor, the location of the vehicle; and
receive, from the second processor, a vehicle dataset comprising vehicle supply chain information.

25. The mobile device according to claim 23, wherein the VIN and the vehicle manufacturing date are stored in a cloud system for analysis of the location of the vehicle.

26. The mobile device according to claim 23, wherein the mobile device processor is configured to execute a plurality of instructions pertaining to scanning a VIN data displayed on a VIN plate of the vehicle.
